(19) United States
(12) Patent Application Publication
(10) Pub. No.: US 2023/0306646 A1
(43) Pub. Date: Sep. 28, 2023

(54) Adaptive Filtering of Occupancy Map for Dynamic Mesh Compression

(71) Applicant: Nokia Technologies Oy, Espoo (FI)

(72) Inventors: Aleksei MARTEMIANOV, Tampere (FI); Sebastian SCHWARZ, Unterhaching (DE); Patrice RONDAO ALFACE, Evere (BE); Lauri Aleksi ILOLA, Munich (DE); Lukasz KONDRAD, Munich (DE)

(21) Appl. No.: 18/121,796

(22) Filed: Mar. 15, 2023

Related U.S. Application Data
(60) Provisional application No. 63/323,342, filed on Mar. 24, 2022.

(51) Int. Cl. G06T 9/00; G06T 17/00

(52) U.S. Cl. CPC G06T 9/001; G06T 17/00

(57) ABSTRACT

An apparatus comprising circuitry configured to: receive as input a three-dimensional mesh represented as at least one geometry patch of an atlas and at least one texture patch of the atlas; create an occupancy map that indicates which pixels of the at least one geometry patch and the at least one texture patch are occupied having a valid value; wherein the occupancy map is configured to be used to reconstruct the mesh; enter lossy mode; apply, while in lossy mode, an adaptive smoothing filter algorithm to the occupancy map to discard at least one edge of the occupancy map, and to reduce a bitrate for transmission of the occupancy map; store, while in lossy mode, the adaptively smoothed occupancy map and at least one occupancy filter threshold; and encode the adaptively smoothed occupancy map and the at least one occupancy filter threshold into a bitstream.

### RELATED APPLICATION

This application claims priority to U.S. Provisional Application No. 63/323,342, filed Mar. 24, 2022, which is hereby incorporated by reference in its entirety.

### TECHNICAL FIELD

The examples and non-limiting embodiments relate generally to volumetric video coding, and more particularly, to adaptive filtering of occupancy map for dynamic mesh compression.

### BACKGROUND

It is known to perform encoding and decoding of images and video.

### SUMMARY

In accordance with an aspect, an apparatus includes: at least one processor; and at least one memory storing instructions that, when executed by the at least one processor, cause the apparatus at least to: receive as input a three-dimensional mesh represented as at least one geometry patch of an atlas and at least one texture patch of the atlas; create an occupancy map that indicates which pixels of the at least one geometry patch and the at least one texture patch are occupied having a valid value; wherein the occupancy map is configured to be used to reconstruct the mesh; enter lossy mode; apply, while in lossy mode, an adaptive smoothing filter algorithm to the occupancy map to discard at least one edge of the occupancy map, and to reduce a bitrate for transmission of the occupancy map; store, while in lossy mode, the adaptively smoothed occupancy map and at least one occupancy filter threshold; and encode the adaptively smoothed occupancy map and the at least one occupancy filter threshold into a bitstream.

In accordance with an aspect, an apparatus includes: at least one processor; and at least one memory storing instructions that, when executed by the at least one processor, cause the apparatus at least to: signal information within a visual volumetric video-based coding extension to indicate a type or format of a content of an atlas, the atlas comprising at least one geometry patch and at least one texture patch used to represent a three-dimensional mesh; wherein the information within the visual volumetric video-based coding extension indicates a bitstream including video content in a domain comprising an adaptively smoothed occupancy map configured to be used to reconstruct the three-dimensional mesh; signal a visual volumetric video-based coding occupancy filter present flag associated with at least one occupancy filter threshold configured to be used to reconstruct the three-dimensional mesh; and signal an occupancy filter threshold syntax element within the visual volumetric video-based coding parameter set extension.

In accordance with an aspect, an apparatus includes: at least one processor; and at least one memory storing instructions that, when executed by the at least one processor, cause the apparatus at least to: decode, from or along a bitstream, an adaptively smoothed occupancy map that indicates which pixels of at least one geometry patch and at least one texture patch are occupied having a valid value; wherein the at least one geometry patch and the at least one texture patch represent an encoded three-dimensional mesh; decode at least one occupancy filter threshold from or along the bitstream; and reconstruct the three-dimensional mesh using the adaptively smoothed occupancy map and the at least one occupancy filter threshold.

### BRIEF DESCRIPTION OF THE DRAWINGS

The foregoing aspects and other features are explained in the following description, taken in connection with the accompanying drawings, wherein:

FIG. 1A is a diagram showing volumetric media conversion at an encoder side.

FIG. 1B is a diagram showing volumetric media reconstruction at a decoder side.

FIG. 2 shows an example of block to patch mapping.

FIG. 3A shows an example of an atlas coordinate system.

FIG. 3B shows an example of a local 3D patch coordinate system.

FIG. 3C shows an example of a final target 3D coordinate system.

FIG. 4 shows elements of a mesh.

FIG. 5 shows an example V-PCC extension for mesh encoding, based on the embodiments described herein.

FIG. 6 shows an example V-PCC extension for mesh decoding, based on the embodiments described herein.

FIG. 7A shows an original occupancy map.

FIG. 7B shows an adaptively filtered occupancy map.

FIG. 8 shows example signaling information added to a V3C extension to differentiate subbitstreams containing video content in a different domain.

FIG. 9 shows signaling that indicates a base threshold used to reconstruct an occupancy map in an atlas having an ID.

FIG. 10 is an example apparatus to implement adaptive filtering of an occupancy map for dynamic mesh compression, based on the examples described herein.

FIG. 11 is an example method to implement adaptive filtering of an occupancy map for dynamic mesh compression, based on the examples described herein.

FIG. 12 is example method to implement adaptive filtering of an occupancy map for dynamic mesh compression, based on the examples described herein.

FIG. 13 is example method to implement adaptive filtering of an occupancy map for dynamic mesh compression, based on the examples described herein.

### DETAILED DESCRIPTION OF EXAMPLE EMBODIMENTS

The examples described herein relate to the encoding, signaling and rendering of a volumetric video that is based on mesh coding. The examples described herein focus on methods improving the quality of reconstructed mesh surfaces. The examples described herein relate to methods to improve quality of decoded mesh textures and geometry by using a hierarchical representation of the mesh textures and geometry which as a consequence increases compression efficiency of the encoding pipeline.

Volumetric Video Data

Volumetric video data represents a three-dimensional scene or object and can be used as input for AR, VR and MR applications. Such data describes geometry (shape, size, position in 3D-space) and respective attributes (e.g. color, opacity, reflectance, . . . ), plus any possible temporal transformations of the geometry and attributes at given time instances (like frames in 2D video). Volumetric video is either generated from 3D models, i.e. CGI, or captured from real-world scenes using a variety of capture solutions, e.g. multi-camera, laser scan, combination of video and dedicated depth sensors, and more. Also, a combination of CGI and real-world data is possible. Typical representation formats for such volumetric data are triangle meshes, point clouds, or voxels. Temporal information about the scene can be included in the form of individual capture instances, i.e. “frames” in 2D video, or other means, e.g. position of an object as a function of time.

Because volumetric video describes a 3D scene (or object), such data can be viewed from any viewpoint. Therefore, volumetric video is an important format for AR, VR, or MR applications, especially for providing 6DOF viewing capabilities.

Increasing computational resources and advances in 3D data acquisition devices have enabled reconstruction of highly detailed volumetric video representations of natural scenes. Infrared, lasers, time-of-flight and structured light are all examples of devices that can be used to construct 3D video data. Representation of the 3D data depends on how the 3D data is used. Dense voxel arrays have been used to represent volumetric medical data. In 3D graphics, polygonal meshes are extensively used. Point clouds on the other hand are well suited for applications such as capturing real world 3D scenes where the topology is not necessarily a 2D manifold. Another way to represent 3D data is coding this 3D data as a set of textures and a depth map as is the case in the multi-view plus depth framework. Closely related to the techniques used in multi-view plus depth is the use of elevation maps, and multi-level surface maps.

MPEG Visual Volumetric Video-Based Coding (V3C)

Selected excerpts from the ISO/IEC 23090-5 Visual Volumetric Video-based Coding and Video-based Point Cloud Compression 2nd Edition standard are referred to herein.

Visual volumetric video, a sequence of visual volumetric frames, if uncompressed, may be represented by a large amount of data, which can be costly in terms of storage and transmission. This has led to the need for a high coding efficiency standard for the compression of visual volumetric data.

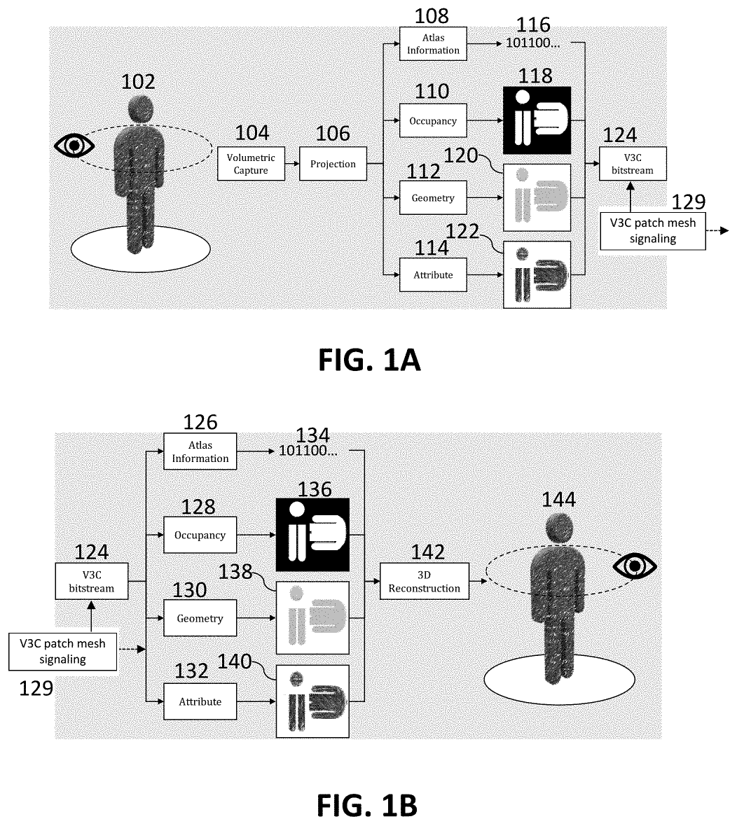

The V3C specification enables the encoding and decoding processes of a variety of volumetric media by using video and image coding technologies. This is achieved through first a conversion of such media from their corresponding 3D representation to multiple 2D representations, also referred to as V3C components, before coding such information. Such representations may include occupancy, geometry, and attribute components. The occupancy component can inform a V3C decoding and/or rendering system of which samples in the 2D components are associated with data in the final 3D representation. The geometry component contains information about the precise location of 3D data in space, while attribute components can provide additional properties, e.g. texture or material information, of such 3D data. An example is shown in FIG. 1A and FIG. 1B.

FIG. 1A shows volumetric media conversion at the encoder, and FIG. 1B shows volumetric media conversion at the decoder side. The 3D media 102 is converted to a series of 2D representations: occupancy 118, geometry 120, and attribute 122. Additional atlas information 108 is also included in the bitstream to enable inverse reconstruction. Refer to ISO/IEC 23090-5.

As further shown in FIG. 1A, a volumetric capture operation 104 generates a projection 106 from the input 3D media 102. In some examples, the projection 106 is a projection operation. From the projection 106, an occupancy operation 110 generates the occupancy 2D representation 118, a geometry operation 112 generates the geometry 2D representation 120, and an attribute operation 114 generates the attribute 2D representation 122. The additional atlas information 108 is included in the bitstream 116. The atlas information 108, the occupancy 2D representation 118, the geometry 2D representation 120, and the attribute 2D representation 122 are encoded into the V3C bitstream 124 to encode a compressed version of the 3D media 102. Based on the examples described herein, V3C patch mesh signaling 129 may also be signaled in the V3C bitstream 124 or directly to a decoder. The V3C patch mesh signaling 129 may be used on the decoder side, as shown in FIG. 1B.

As shown in FIG. 1B, a decoder using the V3C bitstream 124 derives 2D representations using an occupancy operation 128, a geometry operation 130 and an attribute operation 132. The atlas information operation 126 provides atlas information into a bitstream 134. The occupancy operation 128 derives the occupancy 2D representation 136, the geometry operation 130 derives the geometry 2D representation 138, and the attribute operation 132 derives the attribute 2D representation 140. The 3D reconstruction operation 142 generates a decompressed reconstruction 144 of the 3D media 102, using the atlas information 126/134, the occupancy 2D representation 136, the geometry 2D representation 138, and the attribute 2D representation 140.

Additional information that allows associating all these subcomponents and enables the inverse reconstruction, from a 2D representation back to a 3D representation is also included in a special component, referred to herein as the atlas. An atlas consists of multiple elements, namely patches. Each patch identifies a region in all available 2D components and contains information necessary to perform the appropriate inverse projection of this region back to the 3D space. The shape of such regions is determined through a 2D bounding box associated with each patch as well as their coding order. The shape of these regions is also further refined after the consideration of the occupancy information.

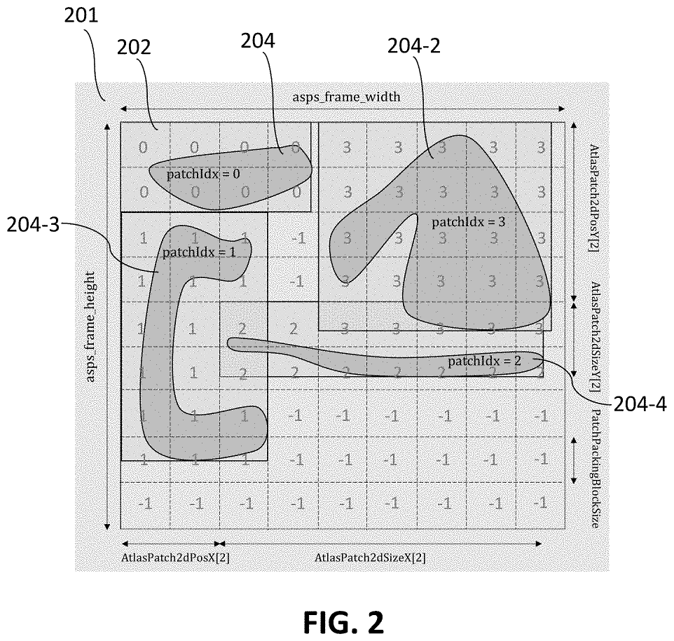

Atlases are partitioned into patch packing blocks of equal size. Refer for example to block 202 in FIG. 2, where FIG. 2 shows an example of block to patch mapping. The 2D bounding boxes of patches and their coding order determine the mapping between the blocks of the atlas image and the patch indices. FIG. 2 shows an example of block to patch mapping with 4 projected patches (204, 204-2, 204-3, 204-4) onto an atlas 201 when asps patch precedence order flag is equal to 0. Projected points are represented with dark gray. The area that does not contain any projected points is represented with light grey. Patch packing blocks 202 are represented with dashed lines. The number inside each patch packing block 202 represents the patch index of the patch (204, 204-2, 204-3, 204-4) to which it is mapped.

Axes orientations are specified for internal operations. For instance, the origin of the atlas coordinates is located on the top-left corner of the atlas frame. For the reconstruction step, an intermediate axes definition for a local 3D patch coordinate system is used. The 3D local patch coordinate system is then converted to the final target 3D coordinate system using appropriate transformation steps.

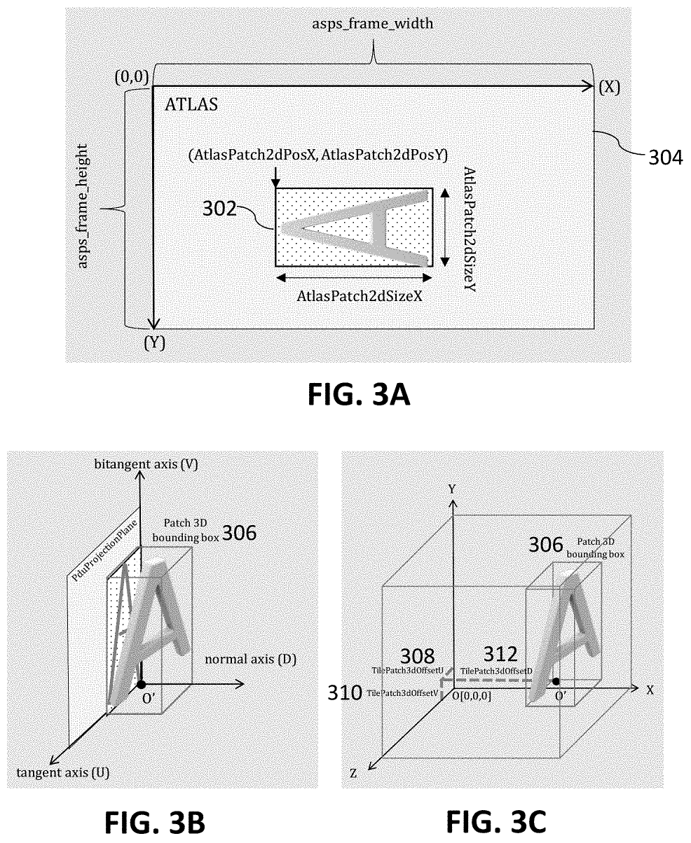

FIG. 3A shows an example of an atlas coordinate system, FIG. 3B shows an example of a local 3D patch coordinate system, and FIG. 3C shows an example of a final target 3D coordinate system. Refer to ISO/IEC 23090-5.

FIG. 3A shows an example of a single patch 302 packed onto an atlas image 304. This patch 302 is then converted, with reference to FIG. 3B, to a local 3D patch coordinate system (U, V, D) defined by the projection plane with origin O′, tangent (U), bi-tangent (V), and normal (D) axes. For an orthographic projection, the projection plane is equal to the sides of an axis-aligned 3D bounding box 306, as shown in FIG. 3B. The location of the bounding box 306 in the 3D model coordinate system, defined by a left-handed system with axes (X, Y, Z), can be obtained by adding offsets TilePatch3dOffsetU 308, TilePatch3DOffsetV 310, and TilePatch3DOffsetD 312, as illustrated in FIG. 3C.

V3C High Level Syntax

Coded V3C video components are referred to herein as video bitstreams, while an atlas component is referred to as the atlas bitstream. Video bitstreams and atlas bitstreams may be further split into smaller units, referred to herein as video and atlas sub-bitstreams, respectively, and may be interleaved together, after the addition of appropriate delimiters, to construct a V3C bitstream.

V3C patch information is contained in an atlas bitstream, atlas_sub_bitstream( ) which contains a sequence of NAL units. A NAL unit is specified to format data and provide header information in a manner appropriate for conveyance on a variety of communication channels or storage media. All data are contained in NAL units, each of which contains an integer number of bytes. A NAL unit specifies a generic format for use in both packet-oriented and bitstream systems. The format of NAL units for both packet-oriented transport and sample streams is identical except that in the sample stream format specified in Annex D of ISO/IEC 23090-5 each NAL unit can be preceded by an additional element that specifies the size of the NAL unit.

NAL units in an atlas bitstream can be divided into atlas coding layer (ACL) and non-atlas coding layer (non-ACL) units. The former is dedicated to carry patch data, while the latter is dedicated to carry data necessary to properly parse the ACL units or any additional auxiliary data.

In the nal_unit_header( ) syntax nal_unit_type specifies the type of the RESP data structure contained in the NAL unit as specified in Table 4 of ISO/IEC 23090-5. nal_layer_id specifies the identifier of the layer to which an ACL NAL unit belongs or the identifier of a layer to which a non-ACL NAL unit applies. The value of nal_layer_id shall be in the range of 0 to 62, inclusive. The value of 63 may be specified in the future by ISO/IEC. Decoders conforming to a profile specified in Annex A of ISO/IEC 23090-5 shall ignore (i.e., remove from the bitstream and discard) all NAL units with values of nal_layer_id not equal to 0.

V3C Extension Mechanisms

While designing the V3C specification it was envisaged that amendments or new editions can be created in the future. In order to ensure that the first implementations of V3C decoders are compatible with any future extension, a number of fields for future extensions to parameter sets were reserved.

For example, the second edition of V3C introduced an extension in VPS related to MIV and the packed video component.

| | |
|---|---|
| ... | |
| vps_extension_present_flag | u(1) |
| if( vps_extension_present_flag ) { | |
| vps_packing_information_present_flag | u(1) |
| vps_miv_extension_present_flag | u(1) |
| vps_extension_6bits | u(6) |
| } | |
| if( vps_packing_information_present_flag ) { | |
| for( k = 0 ; k <= vps_atlas_count_minus1; k++ ) { | |
| j = vps_atlas_id[ k ] | |
| vps_packed_video_present_flag[ j ] | |
| if( vps_packed_video_present_flag[ j ] ) | |
| packing_information( j ) | |
| } | |
| } | |
| if( vps_miv_extension_present_flag ) | |
| vps_miv_extension( ) /*Specified in ISO/IEC 23090-12 (Under | |
| preparation. Stage at time of publication: ISO/IEC CD 23090-12:2020)*/ | |
| if( vps_extension_6bits ) { | |
| vps_extension_length_minus1 | ue(v) |
| for( j = 0; j < vps_extension_length_minus1 + 1; j++ ) { | |
| vps_extension_data_byte | u(8) |
| } | |
| } | |
| byte_alignment( ) | |
| } | |

Rendering and Meshes

A polygon mesh is a collection of vertices, edges and faces that defines the shape of a polyhedral object in 3D computer graphics and solid modeling. The faces usually consist of triangles (triangle mesh), quadrilaterals (quads), or other simple convex polygons (n-gons), since this simplifies rendering, but may also be more generally composed of concave polygons, or even polygons with holes.

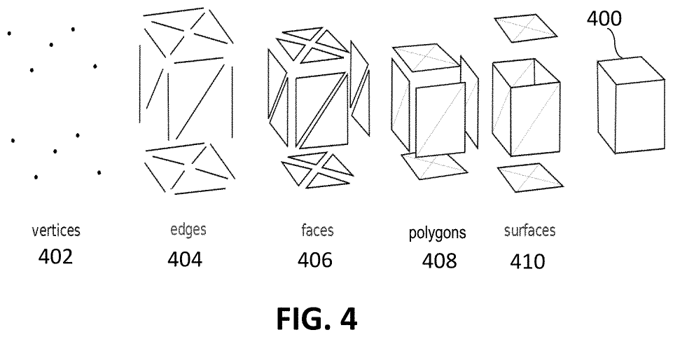

With reference to FIG. 4, objects 400 created with polygon meshes are represented by different types of elements. These include vertices 402, edges 404, faces 406, polygons 408 and surfaces 410 as shown in FIG. 4. Thus, FIG. 4 illustrates elements of a mesh.

Polygon meshes are defined by the following elements:

Vertex (402): a position in 3D space defined as (x,y,z) along with other information such as color (r,g,b), normal vector and texture coordinates.

Edge (404): a connection between two vertices.

Face (406): a closed set of edges 404, in which a triangle face has three edges, and a quad face has four edges. A polygon 408 is a coplanar set of faces 406. In systems that support multi-sided faces, polygons and faces are equivalent. Mathematically a polygonal mesh may be considered an unstructured grid, or undirected graph, with additional properties of geometry, shape and topology.

Surfaces (410): or smoothing groups, are useful, but not required to group smooth regions.

Groups: some mesh formats contain groups, which define separate elements of the mesh, and are useful for determining separate sub-objects for skeletal animation or separate actors for non-skeletal animation.

Materials: defined to allow different portions of the mesh to use different shaders when rendered.

UV coordinates: most mesh formats also support some form of UV coordinates which are a separate 2D representation of the mesh “unfolded” to show what portion of a 2-dimensional texture map to apply to different polygons of the mesh. It is also possible for meshes to contain other such vertex attribute information such as color, tangent vectors, weight maps to control animation, etc. (sometimes also called channels).

V-PCC Mesh Coding Extension (MPEG M49588)

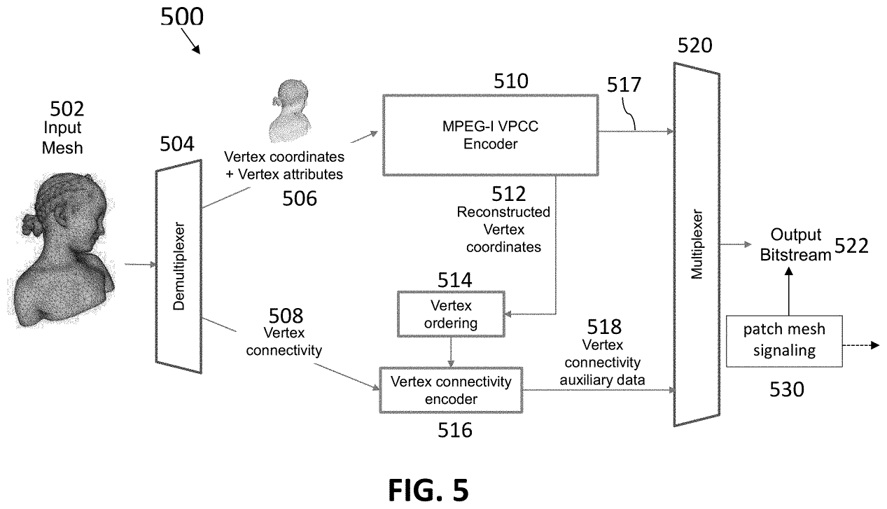

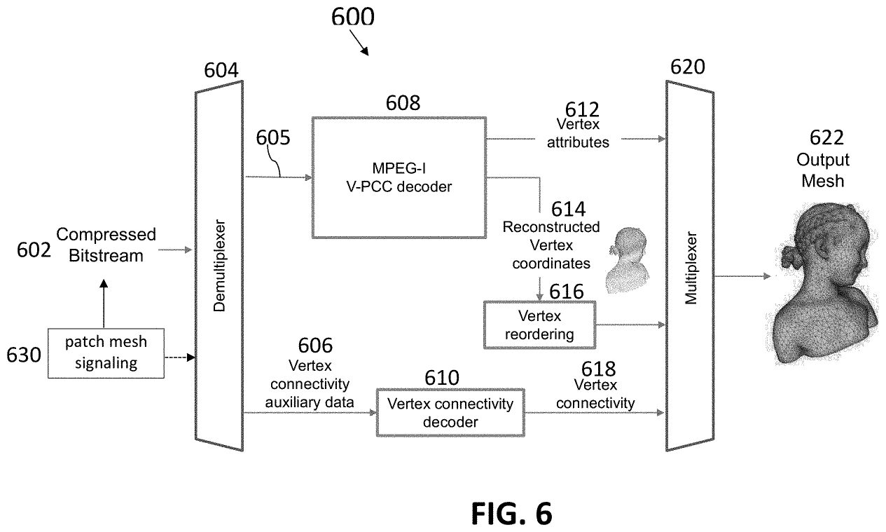

FIG. 5 and FIG. 6 show the extensions to the V-PCC encoder and decoder to support mesh encoding and mesh decoding, respectively, as proposed in MPEG input document [MPEG M47608].

In the encoder extension 500, the input mesh data 502 is demultiplexed with demultiplexer 504 into vertex coordinates+attributes 506 and vertex connectivity 508. The vertex coordinates+attributes data 506 is coded using MPEG-I V-PCC (such as with MPEG-I VPCC encoder 510), whereas the vertex connectivity data 508 is coded (using vertex connectivity encoder 516) as auxiliary data 518. Both of these (encoded vertex coordinates and vertex attributes 517 and auxiliary data 518) are multiplexed using multiplexer 520 to create the final compressed output bitstream 522. Vertex ordering 514 is carried out on the reconstructed vertex coordinates 512 at the output of MPEG-I V-PCC 510 to reorder the vertices for optimal vertex connectivity encoding 516.

Based on the examples described herein, as shown in FIG. 5, the encoding process/apparatus 500 of FIG. 5 may be extended such that the encoding process/apparatus 500 signals patch mesh signaling 530 (e.g. V3C patch mesh signaling) within the output bitstream 522. Alternatively, patch mesh signaling 530 may be provided and signaled separately from the output bitstream 522.

As shown in FIG. 6, in the decoder 600, the input bitstream 602 is demultiplexed with demultiplexer 604 to generate the compressed bitstreams for vertex coordinates+attributes 605 and vertex connectivity 606. The input/compressed bitstream 602 may comprise or may be the output from the encoder 500, namely the output bitstream 522 of FIG. 5. The vertex coordinates+attributes data 605 is decompressed using MPEG-I V-PCC decoder 608 to generate vertex attributes 612. Vertex ordering 616 is carried out on the reconstructed vertex coordinates 614 at the output of MPEG-I V-PCC decoder 608 to match the vertex order at the encoder 500. The vertex connectivity data 606 is also decompressed using vertex connectivity decoder 610 to generate vertex connectivity information 618, and everything (including vertex attributes 612, the output of vertex reordering 616, and vertex connectivity information 618) is multiplexed with multiplexer 620 to generate the reconstructed mesh 622.

Based on the examples described herein, as shown in FIG. 6, the decoding process/apparatus 600 of FIG. 6 may be extended such that the decoding process/apparatus 600 receives and decodes patch mesh signaling 630 (e.g. V3C patch mesh signaling), which may be part of the compressed bitstream 602. The patch mesh signaling 630 of FIG. 6 may comprise or correspond to the patch mesh signaling 530 of FIG. 5. Alternatively, patch mesh signaling 630 may be received and signaled separately from the compressed bitstream 602 or output bitstream 522 (e.g. signaled to the demultiplexer 604 separately from the compressed bitstream 602).

Generic Mesh Compression

Mesh data may be compressed directly without projecting it into 2D-planes, like in V-PCC based mesh coding. In fact, the anchor for V-PCC mesh compression call for proposals (CfP) utilizes off-the shelf mesh compression technology, Draco (https://google.github.io/draco/), for compressing mesh data excluding textures. Draco is used to compress vertex positions in 3D, connectivity data (faces) as well as UV coordinates. Additional per-vertex attributes may be also compressed using Draco. The actual UV texture may be compressed using traditional video compression technologies, such as H.265 or H.264.

Draco uses the edgebreaker algorithm at its core to compress 3D mesh information. Draco offers a good balance between simplicity and efficiency, and is part of Khronos endorsed extensions for the glTF specification. The main idea of the algorithm is to traverse mesh triangles in a deterministic way so that each new triangle is encoded next to an already encoded triangle. This enables prediction of vertex specific information from the previously encoded data by simply adding delta to the previous data. Edgebreaker utilizes symbols to signal how each new triangle is connected to the previously encoded part of the mesh. Connecting triangles in such a way results on average in 1 to 2 bits per triangle when combined with existing binary encoding techniques.

MPEG 3DG (ISO/IEC SC29 WG7) has issued a call for proposals (CfP) on the integration of MESH compression into the V3C family of standards (ISO/IEC 23090-5). During the work on the CfP response of Applicant of the instant disclosure, the Applicant has identified that transmitting the occupancy map in a lossless mode requires large bitrates. Switching to lossy mode does not bring direct advantages, because of the binary nature of the occupancy data, which is not well compressed with DCT-based video codecs.

Further distortion (quantization) of the occupancy map using a 2D video encoder resulted in strong non-linear artifacts in 3D objects (holes, broken surfaces, false faces, spikes) in Applicant's experiments. Efficient compression of occupancy information thus remains unsolved.

Some approaches, such as those that implement lossy compression of point cloud occupancy maps, describe smoothing without adaptivity to smooth out small details and merge some parts of a 3D mesh (or point cloud). Described herein is an approach capable of maintaining such details.

Described herein are methods for improving quality and coding efficiency of occupancy information for 3D meshes in a V3C coding framework. This is achieved by adaptive filtering of the occupancy map to prepare it for lossy video compression.

The main encoder embodiment includes coding efficiency improvement of 3D dynamic meshes by using adaptive filtering of an occupancy map. The main signaling embodiment includes i) per-sequence signaling of occupancy filtering and a base threshold; ii) per-patch delta threshold information (optional threshold+−8); and iii) occupancy map and geometry packing information. The main decoder embodiment includes receiving occupancy filter thresholding information to reverse adaptive filtering during 3D reconstruction.

1. Detailed Problem Description

In V3C coding of 3D data individual frames of dynamic 3D meshes are represented as geometry (GEO) and texture (TEX) patches. For efficient compression by a video encoder, GEO and TEX atlases of patches are padded to generate smooth transition areas between patches and eliminate strong patch borders. This improves compression efficiency dramatically, but also implies the use of an occupancy map to indicate which pixels of patches are occupied (have real values) and should be used to reconstruct the 3D mesh. Therefore as part of the geometry information, the occupancy map is created, coded losslessly and transmitted.

It can be said that the information of the actual patch border was moved from GEO and TEX components into the occupancy map. The occupancy map still requires a lot of bits for transmitting, especially as the occupancy map is typically encoded losslessly.

2. Herein Described Solution

2.1 General

The general idea of the examples described herein is to compress efficiently the occupancy map by switching to lossy mode and applying an adaptive smoothing filter algorithm before passing the occupancy map to a video encoder. The herein described method reduces the bitrate required for occupancy map transmission in lossy mode and improves objective and subjective quality of the reconstructed dynamic 3D mesh.

Advantages and technical effects of this method include bitrate reduction because of smoother frames, better inter-prediction of occupancy map atlases, and accurate reconstruction because of the adaptive nature of the filtering.

### Encoder Embodiments

In an embodiment, the encoder performs the adaptive filtering of the occupancy map in such a way that the decoder can decode the occupancy map correctly using simple thresholding on occupancy values. This threshold is transmitted in the V3C bitstream. In the encoder, an analysis of the occupancy map is performed using a multiscale filtering approach.

In one embodiment, several smoothing levels of the occupancy map are generated by a Gaussian pyramid. Other multiscale filtering approaches can be used, and are not restricted to, a discrete wavelet transform (DWT) analysis or a multi-resolution set of bank filters. Although there is a need for adaptivity, the goal of the filtering is to smooth occupancy edges to reduce bitrate cost in the video encoding step. Hence adaptive filters that preserve edges should be discarded.

Once a set of smoothing levels has been generated, an analysis is performed at the pixel level. For every pixel of the original occupancy map, the smoothing level which gives the possibility to reconstruct the original occupancy value by simple thresholding is selected. If such level is not found, the pixel of the occupancy map is not filtered and left unchanged.

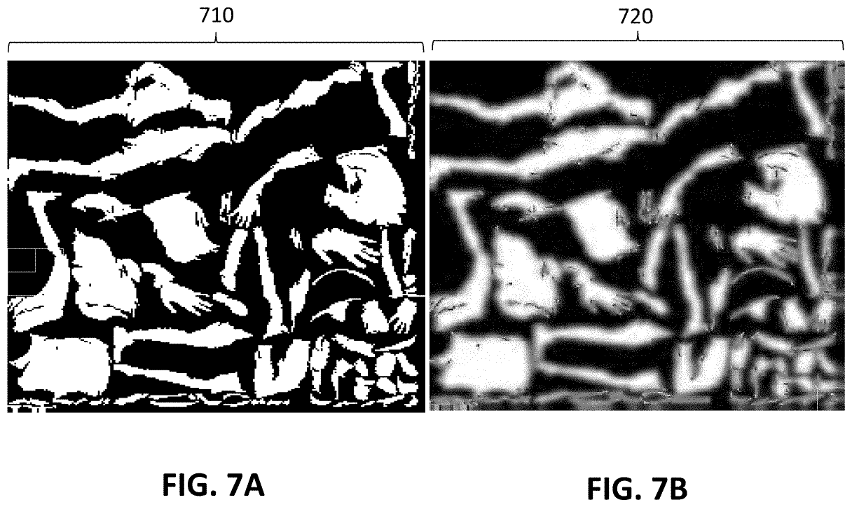

FIG. 7A shows an original occupancy map 710, and FIG. 7B shows an adaptively filtered occupancy map 720 that has been adaptively filtered based on the methods described herein.

In one embodiment, the smoothing level threshold is selected adaptively based on bitdepth requirements. Also, the threshold could be fine-tuned iteratively after per-pixel adaptive filtering. Tuning the threshold is important, because a more accurate threshold generates better occupancy map quality.

2.2 Signaling on the V3C Level

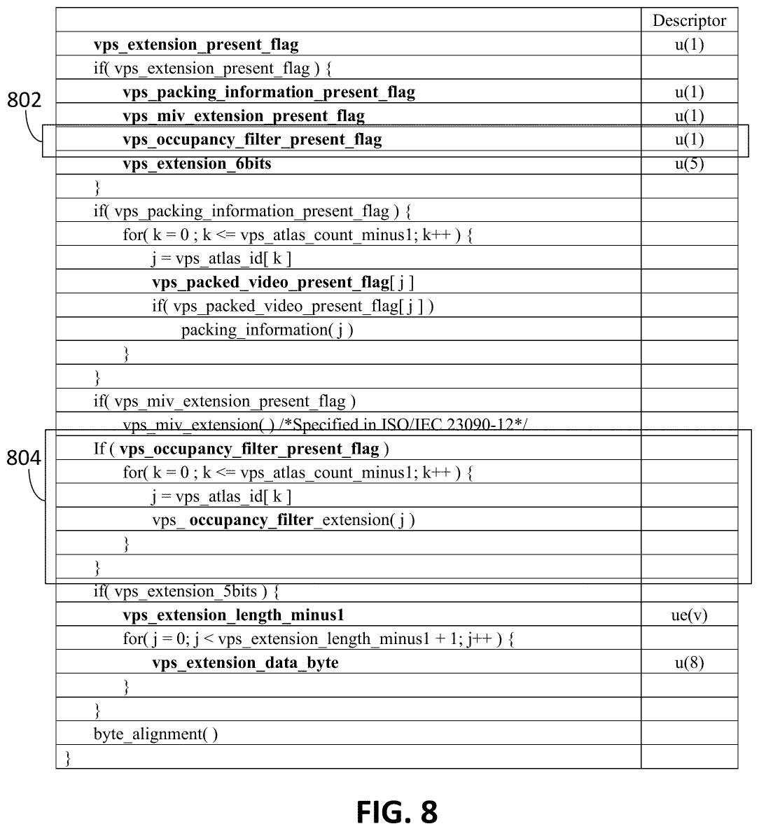

In one embodiment to differentiate the subbitstreams containing video content in a different domain new signaling information is added to the V3C extension that indicates the type and/or format of a content of a given atlas. An excerpt of a VPS syntax table with the new extension is provided below and in FIG. 8 (refer to items 802 and 804).

| | Descriptor |
|---|---|
| vps_extension_present_flag | u(1) |
| if( vps_extension_present_flag ) { | |
| vps_packing_information_present_flag | u(1) |
| vps_miv_extension_present_flag | u(1) |
| vps_occupancy_filter_present_flag | u(1) |
| vps_extension_6bits | u(5) |
| } | |
| if( vps_packing_information_present_flag ) { | |
| for( k = 0 ; k <= vps_atlas_count_minus1; k++ ) { | |
| j = vps_atlas_id[ k ] | |
| vps_packed_video_present_flag[ j ] | |
| if( vps_packed_video_present_flag[ j ] ) | |
| packing_information( j ) | |
| } | |
| } | |
| if( vps_miv_extension_present_flag ) | |
| vps_miv_extension( ) /*Specified in ISO/IEC 23090-12*/ | |
| If ( vps_occupancy_filter_present_flag ) | |
| for( k = 0 ; k <= vps_atlas_count_minus1; k++ ) { | |
| j = vps_atlas_id[ k ] | |
| vps_occupancy_filter_extension( j ) | |
| } | |
| } | |
| if( vps_extension_5bits ) { | |
| vps_extension_length_minus1 | ue(v) |
| for( j = 0; j < vps_extension_length_minus1 + 1; j++ ) { | |
| vps_extension_data_byte | u(8) |
| } | |
| } | |
| byte_alignment( ) | |
| } | |

vps_occupancy_filter_present_flag (item 802) equal to 1 specifies that the vps_occupancy_filter_extension( ) syntax structure is present in the v3c_parameter_set( ) syntax structure. vps_occupancy_filter_present_flag (item 802) equal to 0 specifies that this syntax structure is not present. When not present, the value of vps_occupancy_filter_present_flag (item 802) is inferred to be equal to 0.

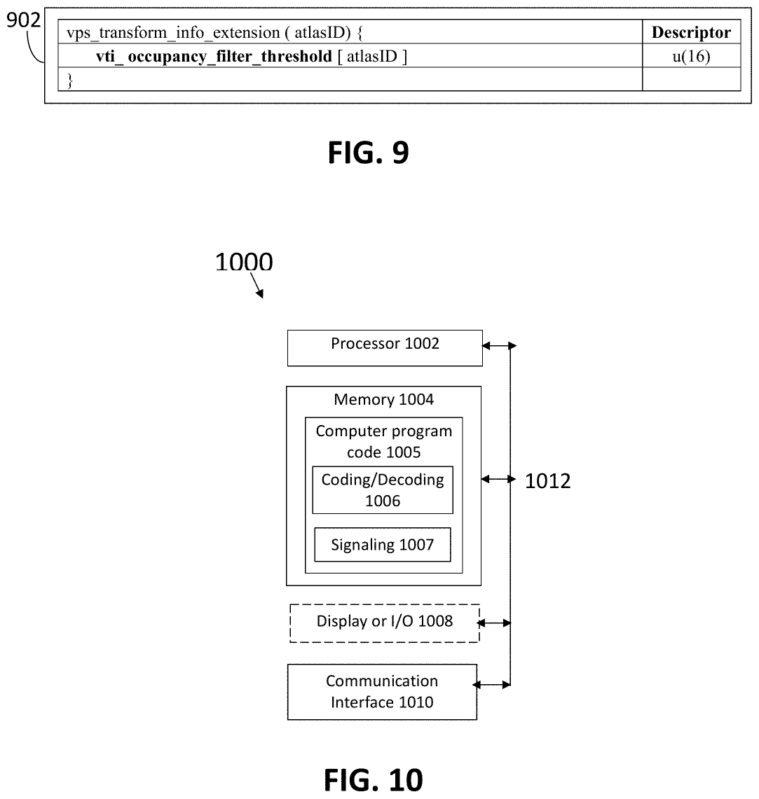

FIG. 9 (item 902) and below shows signaling that indicates a base threshold used to reconstruct an occupancy map in an atlas having an ID.

| | Descriptor |
|---|---|
| vps_transform_info_extension ( atlasID) { | |
| vti_occupancy_filter_threshold[ atlasID ] | u(16) |
| } | |

vti_occupancy_filter_threshold[atlasID] indicates a threshold value which should be used to reconstruct an occupancy map in an atlas with atlas ID equal atlasID. For example, pixels in occupancy with values below vti_occupancy_filter_threshold are defined to indicate unoccupied pixels, and pixels with values higher than or equal to vti_occupancy_filter_threshold indicate occupied values.

In another embodiment the occupancy filter threshold may be signaled as part of a common atlas sequence parameter set, an atlas sequence parameter set, a common atlas frame parameter set, an atlas frame parameter set, or as an SEI message.

Furthermore an additional level of flexibility may be added by enabling signaling of the occupancy filter threshold per patch in a patch data unit.

### Decoder Embodiments

In an embodiment, the decoder receives a V3C bitstream containing occupancy filter threshold information to reverse the adaptive filtering during the 3D reconstruction. The smoothed occupancy map could be directly translated into a binary occupancy map by applying the specified threshold. Alternatively, probability-based restoration could be used. In 3D mesh encoding, the occupancy map contains mostly straight lines of face edges. So, a high probability of line pattern should be used as criteria for proper thresholding.

V3C bitstreams with this feature have additional signaling values. Once the signaling is enabled, the special form of the occupancy map may be like that depicted in FIG. 7B.

The idea described herein, or part of the idea described herein, is to be part of Applicant's response to the mesh coding CfP (where Applicant is the Applicant of the herein described disclosure) and is to be contributed to standardization in SC29/WG7.

FIG. 10 is an apparatus 1000 which may be implemented in hardware, configured to implement adaptive filtering of an occupancy map for dynamic mesh compression, based on any of the examples described herein. The apparatus comprises a processor 1002, at least one memory 1004 (memory 1004 may be non-transitory, transitory, non-volatile or volatile) including computer program code 1005, wherein the at least one memory 1004 and the computer program code 1005 are configured to, with the at least one processor 1002, cause the apparatus to implement circuitry, a process, component, module, function, coding, and/or decoding (collectively 1006) to implement adaptive filtering of an occupancy map for dynamic mesh compression, based on the examples described herein. The apparatus 1000 is further configured to provide or receive signaling 1007, based on the signaling embodiments described herein. The apparatus 1000 optionally includes a display and/or I/O interface 1008 that may be used to display an output (e.g., an image or volumetric video) of a result of coding/decoding 1006. The display and/or I/O interface 1008 may also be configured to receive input such as user input (e.g. with a keypad, touchscreen, touch area, microphone, biometric recognition etc.). The apparatus 1000 also includes one or more communication interfaces (I/F(s)) 1010, such as a network (NW) interface. The communication I/F(s) 1010 may be wired and/or wireless and communicate over a channel or the Internet/other network(s) via any communication technique. The communication I/F(s) 1010 may comprise one or more transmitters and one or more receivers. The communication I/F(s) 1010 may comprise standard well-known components such as an amplifier, filter, frequency-converter, (de)modulator, and encoder/decoder circuitry(ies) and one or more antennas. In some examples, the processor 1002 is configured to implement item 1006 and/or item 1007 without use of memory 1004.

The apparatus 1000 may be a remote, virtual or cloud apparatus. The apparatus 1000 may be either a writer or a reader (e.g. parser), or both a writer and a reader (e.g. parser). The apparatus 1000 may be either a coder or a decoder, or both a coder and a decoder (codec). The apparatus 1000 may be a user equipment (UE), a head mounted display (HMD), or any other fixed or mobile device.

The memory 1004 may be implemented using any suitable data storage technology, such as semiconductor based memory devices, flash memory, magnetic memory devices and systems, optical memory devices and systems, fixed memory and removable memory. The memory 1004 may comprise a database for storing data. Interface 1012 enables data communication between the various items of apparatus 1000, as shown in FIG. 10. Interface 1012 may be one or more buses, or interface 1012 may be one or more software interfaces configured to pass data within computer program code 1005. For example, the interface 1012 may be one or more buses such as address, data, or control buses, and may include any interconnection mechanism, such as a series of lines on a motherboard or integrated circuit, fiber optics or other optical communication equipment, and the like. In another example, interface 1012 is an object-oriented software interface. The apparatus 1000 need not comprise each of the features mentioned, or may comprise other features as well. The apparatus 1000 may be an embodiment of and have the features of any of the apparatuses shown in FIG. 1A, FIG. 1B, FIG. 5, and/or FIG. 6.

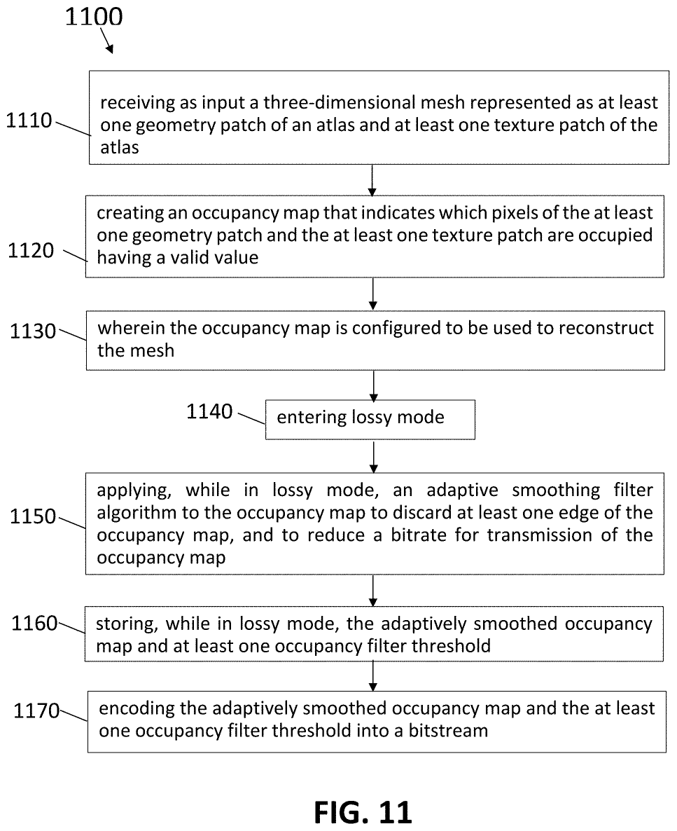

FIG. 11 is a method 1100 to implement adaptive filtering of an occupancy map for dynamic mesh compression, based on the examples described herein. At 1110, the method includes receiving as input a three-dimensional mesh represented as at least one geometry patch of an atlas and at least one texture patch of the atlas. At 1120, the method includes creating an occupancy map that indicates which pixels of the at least one geometry patch and the at least one texture patch are occupied having a valid value. At 1130, the method includes wherein the occupancy map is configured to be used to reconstruct the mesh. At 1140, the method includes entering lossy mode. At 1150, the method includes applying, while in lossy mode, an adaptive smoothing filter algorithm to the occupancy map to discard at least one edge of the occupancy map, and to reduce a bitrate for transmission of the occupancy map. At 1160, the method includes storing, while in lossy mode, the adaptively smoothed occupancy map and at least one occupancy filter threshold. At 1170, the method includes encoding the adaptively smoothed occupancy map and the at least one occupancy filter threshold into a bitstream. Method 1100 may be performed with apparatus 500 or apparatus 1000.

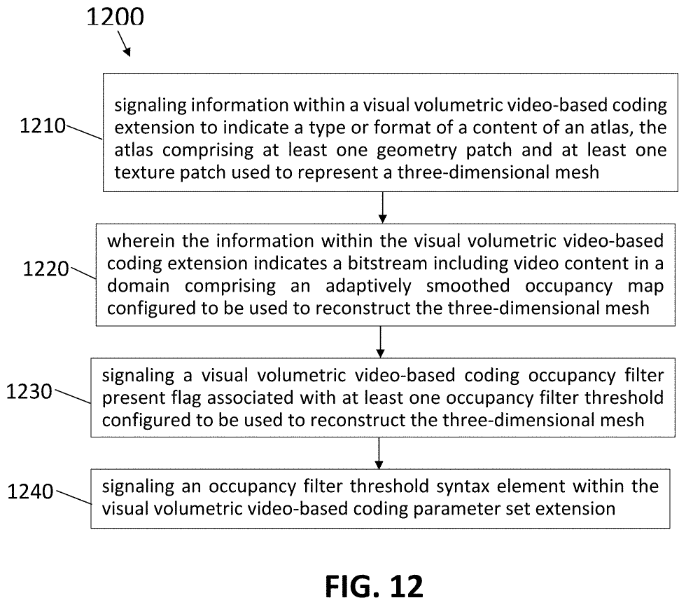

FIG. 12 is a method 1200 to implement adaptive filtering of an occupancy map for dynamic mesh compression, based on the examples described herein. At 1210, the method includes signaling information within a visual volumetric video-based coding extension to indicate a type or format of a content of an atlas, the atlas comprising at least one geometry patch and at least one texture patch used to represent a three-dimensional mesh. At 1220, the method includes wherein the information within the visual volumetric video-based coding extension indicates a bitstream including video content in a domain comprising an adaptively smoothed occupancy map configured to be used to reconstruct the three-dimensional mesh. At 1230, the method includes signaling a visual volumetric video-based coding occupancy filter present flag associated with at least one occupancy filter threshold configured to be used to reconstruct the three-dimensional mesh. At 1240, the method includes signaling an occupancy filter threshold syntax element within the visual volumetric video-based coding parameter set extension. Method 1200 may be performed with apparatus 500 or apparatus 1000.

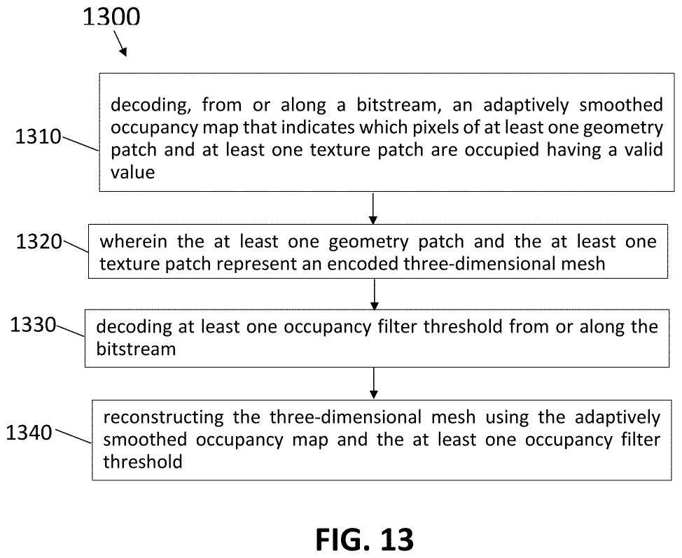

FIG. 13 is a method 1300 to implement adaptive filtering of an occupancy map for dynamic mesh compression, based on the examples described herein. At 1310, the method includes decoding, from or along a bitstream, an adaptively smoothed occupancy map that indicates which pixels of at least one geometry patch and at least one texture patch are occupied having a valid value. At 1320, the method includes wherein the at least one geometry patch and the at least one texture patch represent an encoded three-dimensional mesh. At 1330, the method includes decoding at least one occupancy filter threshold from or along the bitstream. At 1340, the method includes reconstructing the three-dimensional mesh using the adaptively smoothed occupancy map and the at least one occupancy filter threshold. Method 1300 may be performed with apparatus 600 or apparatus 1000.

The following examples 1-29 are described herein.

Example 1: An apparatus includes at least one processor; and at least one memory including computer program code; wherein the at least one memory and the computer program code are configured to, with the at least one processor, cause the apparatus at least to: receive as input a three-dimensional mesh represented as at least one geometry patch of an atlas and at least one texture patch of the atlas; create an occupancy map that indicates which pixels of the at least one geometry patch and the at least one texture patch are occupied having a valid value; wherein the occupancy map is configured to be used to reconstruct the mesh; enter lossy mode; apply, while in lossy mode, an adaptive smoothing filter algorithm to the occupancy map to discard at least one edge of the occupancy map, and to reduce a bitrate for transmission of the occupancy map; store, while in lossy mode, the adaptively smoothed occupancy map and at least one occupancy filter threshold; and encode the adaptively smoothed occupancy map and the at least one occupancy filter threshold into a bitstream.

Example 2: The apparatus of example 1, wherein the at least one memory and the computer program code are further configured to, with the at least one processor, cause the apparatus at least to: generate several smoothing levels of the occupancy map using a multiscale filtering approach.

Example 3: The apparatus of example 2, wherein the multiscale filtering approach comprises: a Gaussian pyramid; a discrete wavelet transform; or a multi-resolution set of bank filters.

Example 4: The apparatus of any of examples 2 to 3, wherein the at least one memory and the computer program code are further configured to, with the at least one processor, cause the apparatus at least to: determine, for a pixel of the occupancy map, one of the smoothing levels that allows reconstruction of an original value of the occupancy map; determine to filter the pixel, in response to determining one of the smoothing levels that allows reconstruction of the original value of the occupancy map; and determine not filter the pixel, in response to not being able to determine one of the smoothing levels that allows reconstruction of the original value of the occupancy map.

Example 5: The apparatus of any of examples 1 to 4, wherein the at least one memory and the computer program code are further configured to, with the at least one processor, cause the apparatus at least to: determine the at least one occupancy filter threshold adaptively based on at least one bitdepth parameter.

Example 6: The apparatus of any of examples 1 to 5, wherein the at least one memory and the computer program code are further configured to, with the at least one processor, cause the apparatus at least to: signal information within a visual volumetric video-based coding extension to indicate a type or format of a content of the atlas, and further to indicate that the bitstream includes video content in a domain comprising the adaptively smoothed occupancy map.

Example 7: The apparatus of any of examples 1 to 6, wherein the at least one memory and the computer program code are further configured to, with the at least one processor, cause the apparatus at least to: signal a visual volumetric video-based coding occupancy filter present flag.

Example 8: The apparatus of example 7, wherein: the visual volumetric video-based coding occupancy filter present flag having a value of one specifies that a visual volumetric video-based coding occupancy filter extension syntax structure is present within a visual volumetric video-based coding parameter set syntax structure; and the visual volumetric video-based coding occupancy filter present flag having a value of zero specifies that the visual volumetric video-based coding occupancy filter extension syntax structure is not present within the visual volumetric video-based coding parameter set syntax structure.

Example 9: The apparatus of any of examples 1 to 8, wherein the at least one memory and the computer program code are further configured to, with the at least one processor, cause the apparatus at least to: signal an occupancy filter threshold syntax element within a visual volumetric video-based coding parameter set extension; wherein the occupancy filter threshold syntax element indicates the at least one occupancy filter threshold configured to be used to reconstruct the occupancy map within an atlas with a given atlas identifier.

Example 10: The apparatus of any of examples 1 to 9, wherein the at least one memory and the computer program code are further configured to, with the at least one processor, cause the apparatus at least to: signal the at least one occupancy filter threshold as part of: a common atlas sequence parameter set; an atlas sequence parameter set; a common atlas frame parameter set; an atlas frame parameter set; or a supplemental enhancement information message.

Example 11: The apparatus of any of examples 1 to 10, wherein the at least one memory and the computer program code are further configured to, with the at least one processor, cause the apparatus at least to: signal the at least one occupancy filter threshold per patch in a patch data unit.

Example 12: An apparatus includes at least one processor; and at least one memory including computer program code; wherein the at least one memory and the computer program code are configured to, with the at least one processor, cause the apparatus at least to: signal information within a visual volumetric video-based coding extension to indicate a type or format of a content of an atlas, the atlas comprising at least one geometry patch and at least one texture patch used to represent a three-dimensional mesh; wherein the information within the visual volumetric video-based coding extension indicates a bitstream including video content in a domain comprising an adaptively smoothed occupancy map configured to be used to reconstruct the three-dimensional mesh; signal a visual volumetric video-based coding occupancy filter present flag associated with at least one occupancy filter threshold configured to be used to reconstruct the three-dimensional mesh; and signal an occupancy filter threshold syntax element within the visual volumetric video-based coding parameter set extension.

Example 13: The apparatus of example 12, wherein: the visual volumetric video-based coding occupancy filter present flag having a value of one specifies that a visual volumetric video-based coding occupancy filter extension syntax structure is present within a visual volumetric video-based coding parameter set syntax structure; and the visual volumetric video-based coding occupancy filter present flag having a value of zero specifies that the visual volumetric video-based coding occupancy filter extension syntax structure is not present within the visual volumetric video-based coding parameter set syntax structure.

Example 14: The apparatus of any of examples 12 to 13, wherein the occupancy filter threshold syntax element indicates the at least one occupancy filter threshold configured to be used to reconstruct the occupancy map within an atlas with a given atlas identifier.

Example 15: The apparatus of any of examples 12 to 14, wherein the at least one memory and the computer program code are further configured to, with the at least one processor, cause the apparatus at least to: signal the at least one occupancy filter threshold as part of: a common atlas sequence parameter set; an atlas sequence parameter set; a common atlas frame parameter set; an atlas frame parameter set; or a supplemental enhancement information message.

Example 16: The apparatus of any of examples 12 to 15, wherein the at least one memory and the computer program code are further configured to, with the at least one processor, cause the apparatus at least to: signal the at least one occupancy filter threshold per patch in a patch data unit.

Example 17: An apparatus comprising: at least one processor; and at least one memory including computer program code; wherein the at least one memory and the computer program code are configured to, with the at least one processor, cause the apparatus at least to: decode, from or along a bitstream, an adaptively smoothed occupancy map that indicates which pixels of at least one geometry patch and at least one texture patch are occupied having a valid value; wherein the at least one geometry patch and the at least one texture patch represent an encoded three-dimensional mesh; decode at least one occupancy filter threshold from or along the bitstream; and reconstruct the three-dimensional mesh using the adaptively smoothed occupancy map and the at least one occupancy filter threshold.

Example 18: The apparatus of example 17, wherein the at least one memory and the computer program code are further configured to, with the at least one processor, cause the apparatus at least to: translate the adaptively smoothed occupancy map into a binary occupancy map, using the at least one occupancy filter threshold.

Example 19: The apparatus of any of examples 17 to 18, wherein the at least one memory and the computer program code are further configured to, with the at least one processor, cause the apparatus at least to: reconstruct the three-dimensional using probability based restoration; wherein the at least one occupancy filter threshold comprises at least one probability of a line pattern of the occupancy map.

Example 20: The apparatus of any of examples 17 to 19, wherein the adaptively smoothed occupancy map has been smoothed in lossy mode using an adaptive smoothing filter algorithm to discard at least one edge of the occupancy map, and to reduce a bitrate for transmission of the occupancy map.

Example 21: A method includes receiving as input a three-dimensional mesh represented as at least one geometry patch of an atlas and at least one texture patch of the atlas; creating an occupancy map that indicates which pixels of the at least one geometry patch and the at least one texture patch are occupied having a valid value; wherein the occupancy map is configured to be used to reconstruct the mesh; entering lossy mode; applying, while in lossy mode, an adaptive smoothing filter algorithm to the occupancy map to discard at least one edge of the occupancy map, and to reduce a bitrate for transmission of the occupancy map; storing, while in lossy mode, the adaptively smoothed occupancy map and at least one occupancy filter threshold; and encoding the adaptively smoothed occupancy map and the at least one occupancy filter threshold into a bitstream.

Example 22: A method including signaling information within a visual volumetric video-based coding extension to indicate a type or format of a content of an atlas, the atlas comprising at least one geometry patch and at least one texture patch used to represent a three-dimensional mesh; wherein the information within the visual volumetric video-based coding extension indicates a bitstream including video content in a domain comprising an adaptively smoothed occupancy map configured to be used to reconstruct the three-dimensional mesh; signaling a visual volumetric video-based coding occupancy filter present flag associated with at least one occupancy filter threshold configured to be used to reconstruct the three-dimensional mesh; and signaling an occupancy filter threshold syntax element within the visual volumetric video-based coding parameter set extension.

Example 23: A method includes decoding, from or along a bitstream, an adaptively smoothed occupancy map that indicates which pixels of at least one geometry patch and at least one texture patch are occupied having a valid value; wherein the at least one geometry patch and the at least one texture patch represent an encoded three-dimensional mesh; decoding at least one occupancy filter threshold from or along the bitstream; and reconstructing the three-dimensional mesh using the adaptively smoothed occupancy map and the at least one occupancy filter threshold.

Example 24: An apparatus includes means for receiving as input a three-dimensional mesh represented as at least one geometry patch of an atlas and at least one texture patch of the atlas; means for creating an occupancy map that indicates which pixels of the at least one geometry patch and the at least one texture patch are occupied having a valid value; wherein the occupancy map is configured to be used to reconstruct the mesh; means for entering lossy mode; means for applying, while in lossy mode, an adaptive smoothing filter algorithm to the occupancy map to discard at least one edge of the occupancy map, and to reduce a bitrate for transmission of the occupancy map; means for storing, while in lossy mode, the adaptively smoothed occupancy map and at least one occupancy filter threshold; and means for encoding the adaptively smoothed occupancy map and the at least one occupancy filter threshold into a bitstream.

Example 25: An apparatus includes means for signaling information within a visual volumetric video-based coding extension to indicate a type or format of a content of an atlas, the atlas comprising at least one geometry patch and at least one texture patch used to represent a three-dimensional mesh; wherein the information within the visual volumetric video-based coding extension indicates a bitstream including video content in a domain comprising an adaptively smoothed occupancy map configured to be used to reconstruct the three-dimensional mesh; means for signaling a visual volumetric video-based coding occupancy filter present flag associated with at least one occupancy filter threshold configured to be used to reconstruct the three-dimensional mesh; and means for signaling an occupancy filter threshold syntax element within the visual volumetric video-based coding parameter set extension.

Example 26: An apparatus includes means for decoding, from or along a bitstream, an adaptively smoothed occupancy map that indicates which pixels of at least one geometry patch and at least one texture patch are occupied having a valid value; wherein the at least one geometry patch and the at least one texture patch represent an encoded three-dimensional mesh; means for decoding at least one occupancy filter threshold from or along the bitstream; and means for reconstructing the three-dimensional mesh using the adaptively smoothed occupancy map and the at least one occupancy filter threshold.

Example 27: A non-transitory program storage device readable by a machine, tangibly embodying a program of instructions executable with the machine for performing operations is described and provided, the operations comprising: receiving as input a three-dimensional mesh represented as at least one geometry patch of an atlas and at least one texture patch of the atlas; creating an occupancy map that indicates which pixels of the at least one geometry patch and the at least one texture patch are occupied having a valid value; wherein the occupancy map is configured to be used to reconstruct the mesh; entering lossy mode; applying, while in lossy mode, an adaptive smoothing filter algorithm to the occupancy map to discard at least one edge of the occupancy map, and to reduce a bitrate for transmission of the occupancy map; storing, while in lossy mode, the adaptively smoothed occupancy map and at least one occupancy filter threshold; and encoding the adaptively smoothed occupancy map and the at least one occupancy filter threshold into a bitstream.

Example 28: A non-transitory program storage device readable by a machine, tangibly embodying a program of instructions executable with the machine for performing operations is described and provided, the operations comprising: signaling information within a visual volumetric video-based coding extension to indicate a type or format of a content of an atlas, the atlas comprising at least one geometry patch and at least one texture patch used to represent a three-dimensional mesh; wherein the information within the visual volumetric video-based coding extension indicates a bitstream including video content in a domain comprising an adaptively smoothed occupancy map configured to be used to reconstruct the three-dimensional mesh; signaling a visual volumetric video-based coding occupancy filter present flag associated with at least one occupancy filter threshold configured to be used to reconstruct the three-dimensional mesh; and signaling an occupancy filter threshold syntax element within the visual volumetric video-based coding parameter set extension.

Example 29: A non-transitory program storage device readable by a machine, tangibly embodying a program of instructions executable with the machine for performing operations is described and provided, the operations comprising: decoding, from or along a bitstream, an adaptively smoothed occupancy map that indicates which pixels of at least one geometry patch and at least one texture patch are occupied having a valid value; wherein the at least one geometry patch and the at least one texture patch represent an encoded three-dimensional mesh; decoding at least one occupancy filter threshold from or along the bitstream; and reconstructing the three-dimensional mesh using the adaptively smoothed occupancy map and the at least one occupancy filter threshold.

References to a ‘computer’, ‘processor’, etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device such as instructions for a processor, or configuration settings for a fixed-function device, gate array or programmable logic device, etc.

As used herein, the term ‘circuitry’ may refer to any of the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. As a further example, as used herein, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device. Circuitry may also be used to mean a function or a process, such as one implemented by an encoder or decoder, or a codec.

In the figures, arrows between individual blocks represent operational couplings there-between as well as the direction of data flows on those couplings.

It should be understood that the foregoing description is only illustrative. Various alternatives and modifications may be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

The following acronyms and abbreviations that may be found in the specification and/or the drawing figures are defined as follows:
2D or 2d two-dimensional
3D or 3d three-dimensional
3DG 3D graphics coding group
6DOF six degrees of freedom
ACL atlas coding layer
AR augmented reality
ASIC application-specific integrated circuit
asps atlas sequence parameter set
CD committee draft
CfP call for proposal(s)
CGI computer-generated imagery
DCT discrete cosine transform
DWT discrete wavelet transform
FPGA field programmable gate array
GEO geometry data of mesh
glTF graphics language transmission format
H.264 advanced video coding video compression standard
H.265 high efficiency video coding video compression standard
HMD head mounted display
id or ID identifier
Idx index
IEC International Electrotechnical Commission
I/F interface
I/O input/output
ISO International Organization for Standardization
miv or MIV MPEG immersive video
MPEG moving picture experts group
MPEG-I MPEG immersive
MR mixed reality
nal or NAL network abstraction layer
NW network
pdu patch data unit
RBSP raw byte sequence payload
SC subcommittee
SEI supplemental enhancement information
TEX texture data of mesh
u(n) unsigned integer using n bits, e.g. u(1), u(2)
UE user equipment
ue(v) unsigned integer exponential Golomb coded syntax element with the left bit first
UV coordinate texture, where “U” and “V” are axes of a 2D texture
V3C visual volumetric video-based coding
VPCC or V-PCC video-based point cloud coding/compression
vps or VPS V3C parameter set
VR virtual reality
WG working group

What is claimed is:

1. An apparatus comprising:
at least one processor; and
at least one memory storing instructions that, when executed by the at least one processor, cause the apparatus at least to:
receive as input a three-dimensional mesh represented as at least one geometry patch of an atlas and at least one texture patch of the atlas;
create an occupancy map that indicates which pixels of the at least one geometry patch and the at least one texture patch are occupied having a valid value;
wherein the occupancy map is configured to be used to reconstruct the mesh;
enter lossy mode;
apply, while in lossy mode, an adaptive smoothing filter algorithm to the occupancy map to discard at least one edge of the occupancy map, and to reduce a bitrate for transmission of the occupancy map;
store, while in lossy mode, the adaptively smoothed occupancy map and at least one occupancy filter threshold; and
encode the adaptively smoothed occupancy map and the at least one occupancy filter threshold into a bitstream.

2. The apparatus of claim 1, wherein the instructions, when executed by the at least one processor, cause the apparatus at least to:
generate several smoothing levels of the occupancy map using a multiscale filtering approach.

3. The apparatus of claim 2, wherein the multiscale filtering approach comprises:
a Gaussian pyramid;
a discrete wavelet transform; or
a multi-resolution set of bank filters.

4. The apparatus of claim 2, wherein the instructions, when executed by the at least one processor, cause the apparatus at least to:
determine, for a pixel of the occupancy map, one of the smoothing levels that allows reconstruction of an original value of the occupancy map;
determine to filter the pixel, in response to determining one of the smoothing levels that allows reconstruction of the original value of the occupancy map; and
determine not filter the pixel, in response to not being able to determine one of the smoothing levels that allows reconstruction of the original value of the occupancy map.

5. The apparatus of claim 1, wherein the instructions, when executed by the at least one processor, cause the apparatus at least to:
determine the at least one occupancy filter threshold adaptively based on at least one bitdepth parameter.

6. The apparatus of claim 1, wherein the instructions, when executed by the at least one processor, cause the apparatus at least to:
signal information within a visual volumetric video-based coding extension to indicate a type or format of a content of the atlas, and further to indicate that the bitstream includes video content in a domain comprising the adaptively smoothed occupancy map.

7. The apparatus of claim 1, wherein the instructions, when executed by the at least one processor, cause the apparatus at least to:
signal a visual volumetric video-based coding occupancy filter present flag.

8. The apparatus of claim 7, wherein:
the visual volumetric video-based coding occupancy filter present flag having a value of one specifies that a visual volumetric video-based coding occupancy filter extension syntax structure is present within a visual volumetric video-based coding parameter set syntax structure; and
the visual volumetric video-based coding occupancy filter present flag having a value of zero specifies that the visual volumetric video-based coding occupancy filter extension syntax structure is not present within the visual volumetric video-based coding parameter set syntax structure.

9. The apparatus of claim 1, wherein the instructions, when executed by the at least one processor, cause the apparatus at least to:
signal an occupancy filter threshold syntax element within a visual volumetric video-based coding parameter set extension;
wherein the occupancy filter threshold syntax element indicates the at least one occupancy filter threshold configured to be used to reconstruct the occupancy map within an atlas with a given atlas identifier.

10. The apparatus of claim 1, wherein the instructions, when executed by the at least one processor, cause the apparatus at least to:
signal the at least one occupancy filter threshold as part of:
a common atlas sequence parameter set;
an atlas sequence parameter set;
a common atlas frame parameter set;
an atlas frame parameter set; or
a supplemental enhancement information message.

11. The apparatus of claim 1, wherein the instructions, when executed by the at least one processor, cause the apparatus at least to:
signal the at least one occupancy filter threshold per patch in a patch data unit.

12. An apparatus comprising:
at least one processor; and
at least one memory storing instructions that, when executed by the at least one processor, cause the apparatus at least to:
signal information within a visual volumetric video-based coding extension to indicate a type or format of a content of an atlas, the atlas comprising at least one geometry patch and at least one texture patch used to represent a three-dimensional mesh;
wherein the information within the visual volumetric video-based coding extension indicates a bitstream including video content in a domain comprising an adaptively smoothed occupancy map configured to be used to reconstruct the three-dimensional mesh;
signal a visual volumetric video-based coding occupancy filter present flag associated with at least one occupancy filter threshold configured to be used to reconstruct the three-dimensional mesh; and
signal an occupancy filter threshold syntax element within the visual volumetric video-based coding parameter set extension.

13. The apparatus of claim 12, wherein:
the visual volumetric video-based coding occupancy filter present flag having a value of one specifies that a visual volumetric video-based coding occupancy filter extension syntax structure is present within a visual volumetric video-based coding parameter set syntax structure; and
the visual volumetric video-based coding occupancy filter present flag having a value of zero specifies that the visual volumetric video-based coding occupancy filter extension syntax structure is not present within the visual volumetric video-based coding parameter set syntax structure.

14. The apparatus of claim 12, wherein the occupancy filter threshold syntax element indicates the at least one occupancy filter threshold configured to be used to reconstruct the occupancy map within an atlas with a given atlas identifier.

15. The apparatus of claim 12, wherein the instructions, when executed by the at least one processor, cause the apparatus at least to:
signal the at least one occupancy filter threshold as part of:
a common atlas sequence parameter set;
an atlas sequence parameter set;
a common atlas frame parameter set;
an atlas frame parameter set; or
a supplemental enhancement information message.

16. The apparatus of claim 12, wherein the instructions, when executed by the at least one processor, cause the apparatus at least to:
signal the at least one occupancy filter threshold per patch in a patch data unit.

17. An apparatus comprising:
at least one processor; and
at least one memory storing instructions that, when executed by the at least one processor, cause the apparatus at least to:
decode, from or along a bitstream, an adaptively smoothed occupancy map that indicates which pixels of at least one geometry patch and at least one texture patch are occupied having a valid value;
wherein the at least one geometry patch and the at least one texture patch represent an encoded three-dimensional mesh;
decode at least one occupancy filter threshold from or along the bitstream; and
reconstruct the three-dimensional mesh using the adaptively smoothed occupancy map and the at least one occupancy filter threshold.

18. The apparatus of claim 17, wherein the instructions, when executed by the at least one processor, cause the apparatus at least to:
translate the adaptively smoothed occupancy map into a binary occupancy map, using the at least one occupancy filter threshold.

19. The apparatus of claim 17, wherein the instructions, when executed by the at least one processor, cause the apparatus at least to:
reconstruct the three-dimensional using probability based restoration;
wherein the at least one occupancy filter threshold comprises at least one probability of a line pattern of the occupancy map.

20. The apparatus of claim 17, wherein the adaptively smoothed occupancy map has been smoothed in lossy mode using an adaptive smoothing filter algorithm to discard at least one edge of the occupancy map, and to reduce a bitrate for transmission of the occupancy map.
